(19) United States
(12) Patent Application Publication
(10) Pub. No.: US 2005/0080576 A1
(43) Pub. Date: Apr. 14, 2005

(54) Method and system for frequency domain time correlation

(76) Inventors: Robert T. Dickerson, Spokane, WA (US); George S. Moore, Veradale, WA (US)

Correspondence Address: AGILENT TECHNOLOGIES, INC.;Intellectual Property Administration, Legal Department, DL429, P.O. Box 7599, Loveland, CO, 80537-0599, US

(21) Appl. No.: 10/683,193

(22) Filed: Oct. 10, 2003

(51) Int. Cl. G06F 19/00

(52) U.S. Cl. 702/76

(57) ABSTRACT

Time domain data in a measurement signal and in a reference signal are converted to frequency domain data. The reference signal and the measurement signal are then multiplied and the resulting product data converted to delay domain data. During the correlation process, the frequency of one of the signals, such as the reference signal, is varied. The frequency of the reference signal may be adjusted a predetermined number of times, and each of the resulting correlated signals examined. The frequency that produces the strongest correlation is selected. Alternatively, the frequency of the reference signal may be adjusted until a correlation value for the correlated signal matches or exceeds a threshold value. The frequency that first results in a correlation value that matches or exceeds the threshold value is selected. The frequency of a signal may be adjusted in integer and fractional amounts.

### TECHNICAL FIELD

The invention relates generally to communications, and more particularly to time correlation in communication measurements. Still more particularly, the invention relates to a method and system for frequency domain time correlation.

### BACKGROUND

Time correlation is frequently used in the testing of communication devices, and typically involves synchronizing the timing of the measurement equipment to the timing of the device being tested. The synchronization process also includes accommodation of the frequency errors and noise generated by the device during testing. Once the synchronization process is complete, the measurement equipment can proceed with the testing process.

FIG. 1 is a block diagram of a correlation system according to the prior art. Correlation system 100 includes frequency correction 102 and correlation 104. A measurement signal from a device to be tested is input into correlation 104 via signal line 106. A reference signal is input into frequency correction 102 via signal line 108. Frequency correction 102 typically applies the frequency corrections to the reference signal to match the errors in the measurement signal.

The frequency-corrected reference signal is then input into correlation 104 via signal line 110. The frequency-corrected reference signal and the measurement signal are correlated to determine how closely the timing of the measurement signal matches the timing of the reference signal. A correlation response is then output on signal line 114.

Time correlation can be performed in the time domain and in the frequency domain. For some applications, performing time correlation in the frequency domain is faster than in the time domain, and the timing of the measurement signal can be calculated once its frequency error is known. FIG. 2 is a block diagram of a frequency domain time correlation system according to the prior art. Correlation system 200 includes frequency correction 102 and correlation 104. A reference signal is input into frequency correction 102 to match the frequency errors in the measurement signal.

The frequency-corrected reference signal and a measurement signal are then input into correlation 104. Transform 202 converts the time domain data in the measurement signal into frequency domain data. Transform 204 converts the time domain data in the frequency-corrected reference signal into frequency domain data. Multiplication 206 multiplies the two signals and inputs the resulting product data into inverse transform 208. Inverse transform 208 transforms the resulting product data into delay domain data.

Unfortunately, correlation system 200 operates less effectively and efficiently as the size of the frequency errors and noise levels increase. Computational efficiency is reduced when the frequency correction and the correlation process are performed separately. Furthermore, the correlation systems of FIGS. 1 and 2 typically utilize a format-specific algorithm for frequency measurement that does not provide a generalized solution.

### SUMMARY

In accordance with the invention, a method and system for frequency domain time correlation is provided. Time domain data in a measurement signal and in a reference signal are converted to frequency domain data. The reference signal and the measurement signal are then multiplied and the resulting product data converted to delay domain data. During this process, the frequency of the reference signal is varied. In one embodiment in accordance with the invention, the frequency of the reference signal is adjusted a predetermined number of times and the frequency that produces the strongest correlation selected. In another embodiment in accordance with the invention, the frequency of the reference signal is adjusted until a correlation value for the correlated data matches or exceeds a threshold value. The threshold value provides flexibility in the correlation search by allowing the correlation system to find correlation when the frequency of the reference signal achieves an acceptable equivalence to the frequency of the measurement signal. Embodiments in accordance with the invention, however, are not limited to adjusting the frequency of the reference signal. The frequency of the measurement signal may be adjusted instead of the frequency of the reference signal. Furthermore, the frequency of a signal may be adjusted in integer and fractional amounts.

### BRIEF DESCRIPTION OF THE DRAWINGS

The invention will best be understood by reference to the following detailed description of embodiments in accordance with the invention when read in conjunction with the accompanying drawings, wherein:

FIG. 1 is a block diagram of a correlation system according to the prior art;

FIG. 2 is a block diagram of a frequency domain time correlation system according to the prior art;

FIG. 3 is a flowchart of a method for frequency domain time correlation in a first embodiment in accordance with the invention;

FIG. 4 is a block diagram of a frequency domain time correlation system in accordance with the first embodiment of FIG. 3;

FIG. 5 is a flowchart of a method for frequency domain time correlation in a second embodiment in accordance with the invention;

FIG. 6 is a block diagram of a frequency domain time correlation system in accordance with the second embodiment of FIG. 5;

FIG. 7 is a flowchart of a method for frequency domain time correlation in a third embodiment in accordance with the invention;

FIG. 8 is a block diagram of a frequency domain time correlation system in accordance with the third embodiment of FIG. 7;

FIG. 9 is a flowchart of a method for frequency domain time correlation in a fourth embodiment in accordance with the invention;

FIG. 10 is a block diagram of a frequency domain time correlation system in accordance with the fourth embodiment of FIG. 9;

FIG. 11 is a flowchart of a method for frequency domain time correlation in a fifth embodiment in accordance with the invention;

FIG. 12 is a waveform diagram of a correlated signal in accordance with the fifth embodiment of FIG. 11;

FIG. 13 is a block diagram of a frequency domain time correlation system in accordance with the fifth embodiment of FIG. 11; and

FIG. 14 is a block diagram of a frequency domain time correlation system in a sixth embodiment in accordance with the invention.

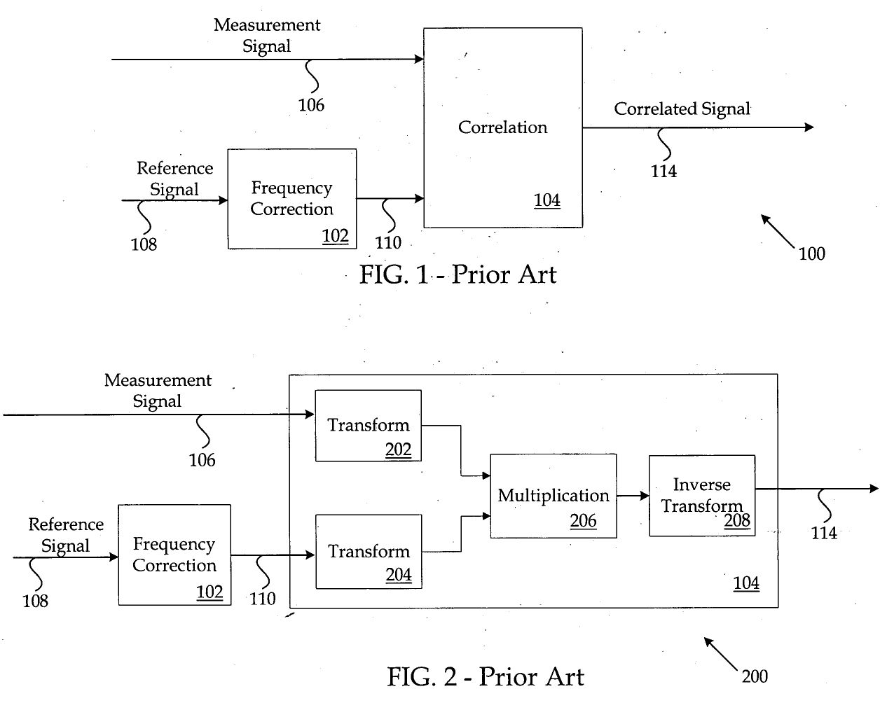

### DETAILED DESCRIPTION

The invention relates to a method and system for frequency domain time correlation. The following description is presented to enable one skilled in the art to make and use the invention, and is provided in the context of a patent application and its requirements. Various modifications to the disclosed embodiments will be readily apparent to those skilled in the art, and the generic principles herein may be applied to other embodiments. Thus, the invention is not intended to be limited to the embodiments shown, but is to be accorded the widest scope consistent with the appended claims and with the principles and features described herein.

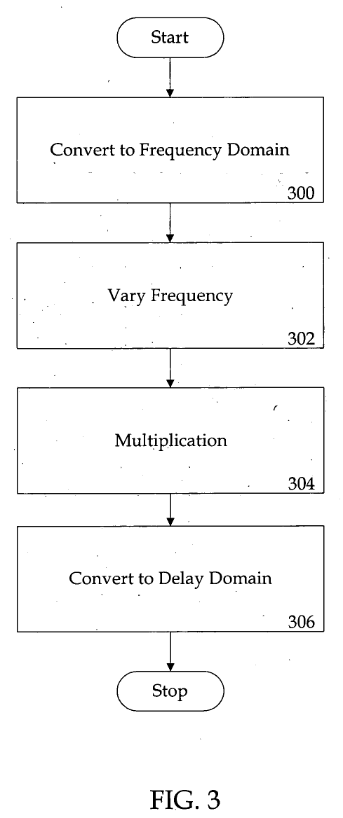

With reference now to the figures and in particular with reference to FIG. 3, there is shown a flowchart of a method for frequency domain time correlation in a first embodiment in accordance with the invention. The process begins at block 300 where time domain data is converted to frequency domain data. The time domain data in the FIG. 3 embodiment includes a measurement signal and a reference signal. The frequency of one of the signals is then varied, as shown in block 302.

The frequency domain data in the measurement signal and the frequency domain data in the reference signal are then multiplied, as shown in block 304. The resulting product data are then converted to delay domain data at block 306 and the process ends. In this embodiment in accordance with the invention, a strong correlation occurs in the inverse transform output data when the frequency of the reference signal, through frequency variation, matches or nearly matches the frequency of the measurement signal.

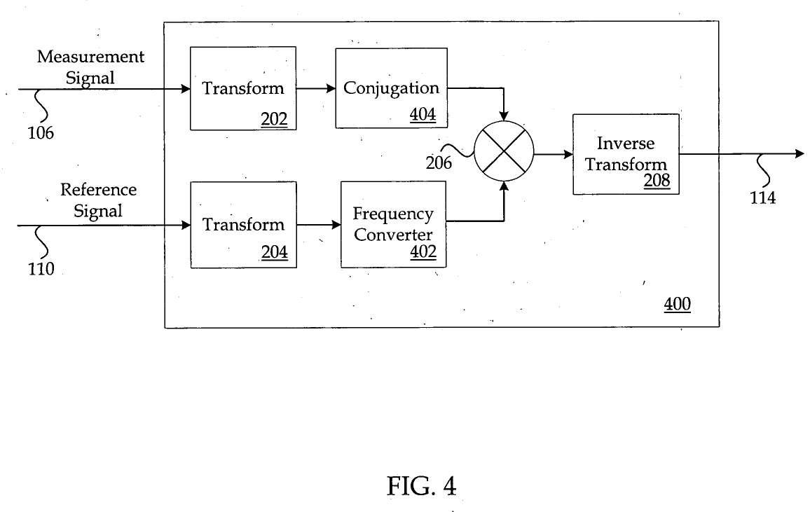

FIG. 4 is a block diagram of a frequency domain time correlation system in accordance with the first embodiment of FIG. 3. Correlation system 400 includes transforms 202, 204, multiplication 206, inverse transform 208, frequency converter 402, and conjugation 404. A measurement signal is input into transform 202 via signal line 106 and a reference signal is input into transform 204 via signal line 110. Transforms 202 and 204 convert the time domain data in the signals to frequency domain data.

Frequency converter 402 receives the frequency domain data in the reference signal and varies the frequency of the signal. Conjugation 404 receives the frequency domain data in the measurement signal and conjugates (i.e. inverts the imaginary parts of) the data values. Multiplier 206 then multiplies the frequency domain data in the reference signal with the conjugate of the frequency domain data in the measurement signal. The resulting product data are input into inverse transform 208, which converts the data into delay domain data. A strong correlation occurs in the inverse transform output data in the FIG. 4 embodiment when the frequency of the reference signal, through frequency variation, matches (or nearly matches) the frequency of the measurement signal.

The measurement signal and the reference signal are sampled signals in this embodiment in accordance with the invention. Transforms 202, 204 are implemented as fast Fourier transforms (FFT) while inverse transform 208 is implemented as an inverse fast Fourier transform (IFFT). Multiplier 206 therefore, performs element-by-element vector multiplication, also known as Hadamard multiplication. In other embodiments in accordance with the invention, conversion techniques other than FFTs and IFFTs may be utilized. An example of one such technique is a discrete Fourier transform (DFT) and an inverse discrete Fourier transform (IDFT). The selection of a conversion technique is typically influenced by the specific parameters in each application. Those skilled in the art will recognize the accommodations necessary to adapt the circular correlation that naturally results from this processing to the desired linear correlation. Those skilled in the art will also recognize that, for periodic reference signals, circular correlation may be used to further reduce the computational complexity.

Frequency converter 402 varies the frequency of the reference signal by rotating the data in the reference signal in this embodiment in accordance with the invention. For example, the reference signal transform data may include four data values [D₁, D₂, D₃, D₄]. The data values become [D₄, D₁, D₂, D₃] when the data are rotated up one position. Rotation of the data values varies the frequency of the reference signal by integer values in this embodiment. A reference signal may include any number of data values in other embodiments in accordance with the invention.

Furthermore, the frequency of the reference signal may be varied in any desired sequence. For example, the frequency may be varied by ±1, ±2, ±3, etc., or by ±2, ±4, ±6, etc. In this embodiment in accordance with the invention, the frequency of the reference signal is shifted sequentially over the entire range of frequencies correlation system 400 accommodates. For each frequency in the frequency range, the reference data are rotated accordingly, multiplied with the conjugate of the frequency domain data in the measurement signal, and input into the inverse transform 208. The resulting correlation data are then examined for each frequency. The data containing the strongest correlation represents a match or near match between the timing of the measurement signal and the timing of the reference signal in the FIG. 4 embodiment.

Those skilled in the art will appreciate that the frequency of the reference signal may be varied differently in other embodiments in accordance with the invention. For example, the frequency domain data in a signal may be shifted in an ordered pattern over a limited range of frequencies. The pattern is typically governed by the specific parameters in each application.

Other embodiments in accordance with the invention may also eliminate conjugation 404 by utilizing convolution with time reversal with the measurement signal. Convolution with time reversal is equivalent to conjugation. In these other embodiments, the transformed time-reversed measurement signal is input directly into multiplier 206, where the reference signal transform is multiplied element-by-element with the time reversed measurement signal transform. The resulting product data are then input into inverse transform 208.

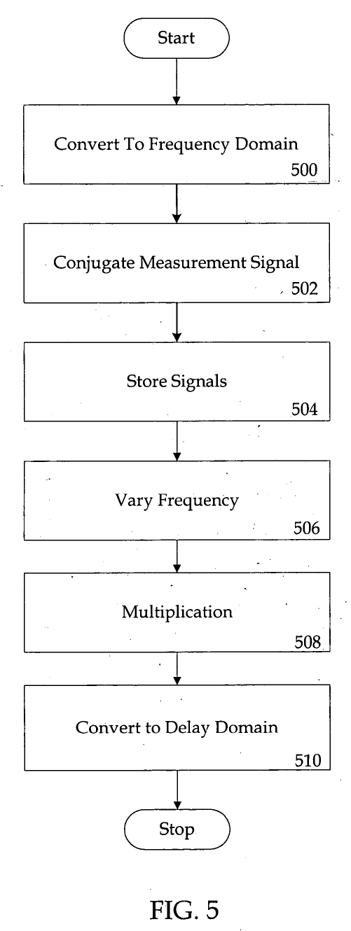

Referring now to FIG. 5, there is shown a flowchart of a method for frequency domain time correlation in a second embodiment in accordance with the invention. The process begins at block 500 where time domain data is converted to frequency domain data. The time domain data in the FIG. 5 embodiment includes a measurement signal and a reference signal. Next, the conjugate of the measurement signal transform is generated, as shown at block 502. The conjugate of the measurement signal transform and the reference signal transform are then stored in a memory (block 504). In this embodiment in accordance with the invention, the reference signal does not vary and therefore can be pre-computed and transformed into frequency domain data prior to being stored in memory.

Next, the reference signal is read out of memory and the frequency of the signal varied, as shown in block 506. The frequency domain data in the measurement signal and the frequency domain data in the reference signal are then multiplied, as shown in block 508. The resulting product data are converted to delay domain data at block 510 and the process ends. A strong correlation occurs in the inverse transform output data in this embodiment in accordance with the invention when the frequency of the reference signal, through frequency variation, matches or nearly matches the frequency of the measurement signal.

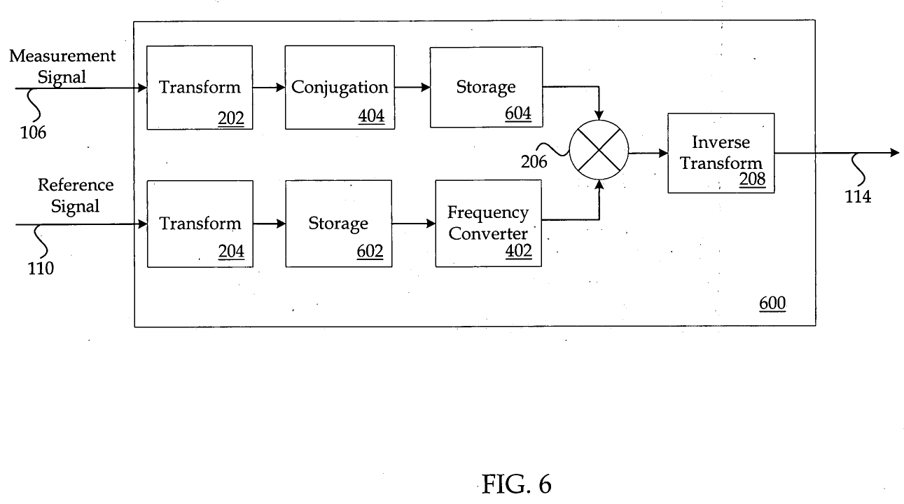

FIG. 6 is a block diagram of a frequency domain time correlation system in accordance with the second embodiment of FIG. 5. Correlation system 600 includes transforms 202, 204, multiplication 206, inverse transform 208, frequency converter 402, conjugation 404, storage 602, and storage 604. Transforms 202, 204, multiplier 206, inverse transform 208, frequency converter 402, and conjugation 404 function as described in conjunction with FIG. 4 in this embodiment in accordance with the invention.

A reference signal is input into transform 204 to convert the time domain data in the signal into frequency domain data. The transformed reference signal is then stored in storage 602. In this embodiment in accordance with the invention, the reference signal does not vary and therefore can be pre-computed and transformed into frequency domain data prior to being stored in memory. Multiple transformed reference signals may be stored in storage 602 in other embodiments in accordance with the invention.

A measurement signal is input into transform 202 to convert the time domain data in the signal into frequency domain data. Conjugation 404 receives the frequency domain data in the measurement signal and conjugates the transform data. The conjugate of the measurement signal is then stored in storage 604.

Frequency converter 402 reads the frequency domain data out of storage 602 and varies the frequency of the signal. Multiplier 206 then multiplies the frequency domain data in the reference signal with the conjugate of the frequency domain data in the measurement signal. The resulting product data are input into inverse transform 208, which converts the data into delay domain data. In the FIG. 6 embodiment, a strong correlation occurs in the inverse transform output data when the frequency of the reference signal, through frequency variation, matches (or nearly matches) the frequency of the measurement signal.

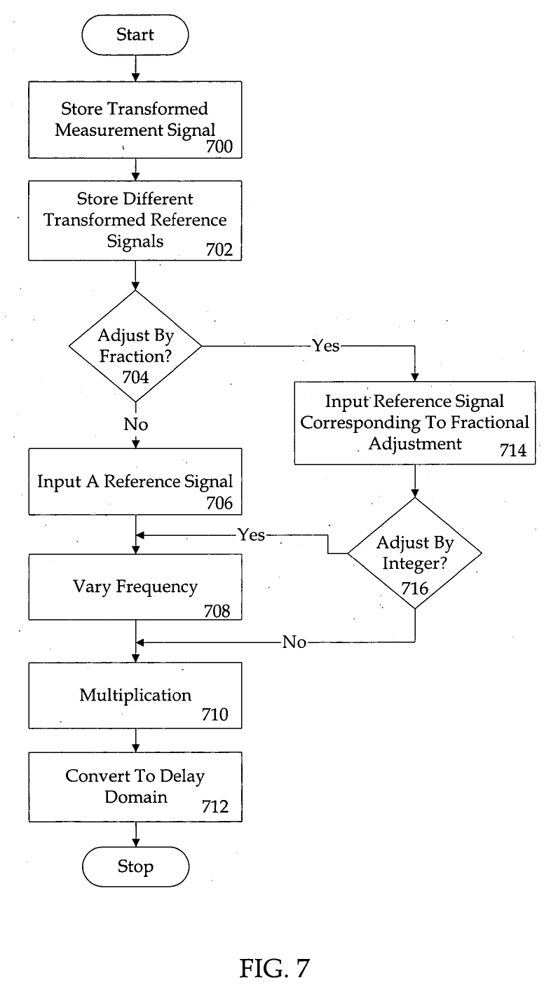

Referring now to FIG. 7, there is shown a flowchart of a method for frequency domain time correlation in a third embodiment in accordance with the invention. The process begins at block 700 where a transformed measurement signal is stored in a memory. The transformed measurement signal is a signal containing frequency domain data. Next, multiple transformed reference signals are stored in a memory, as shown in block 702. The multiple transformed reference signals are signals whose time domain data has been converted to frequency domain data. Furthermore, one of the stored reference signals is not adjusted in frequency, while the remaining stored reference signals adjust the frequency by a different fractional amount. The stored reference signals may be pre-calculated.

A determination is made at block 704 as to whether the frequency of the reference signal is to be adjusted by a fractional amount. If not, the unadjusted reference signal is selected and its frequency varied by an integer amount, as shown in blocks 706 and 708. The reference signal and the measurement signal are then multiplied at block 710. The resulting product data are converted to delay domain data and the process ends.

Returning to block 704, if the frequency of a reference signal is to be adjusted by a fractional amount, the process passes to block 714 where a reference signal corresponding to the fractional adjustment is selected. A determination is then made as to whether the frequency of the selected reference signal is to be adjusted by an integer amount. If not, the process passes to block 710 and continues through block 712. If the frequency of the selected reference signal is to be adjusted by an integer amount, the process passes to block 708 where the frequency is adjusted by the integer amount. The process then continues through blocks 710 and 712.

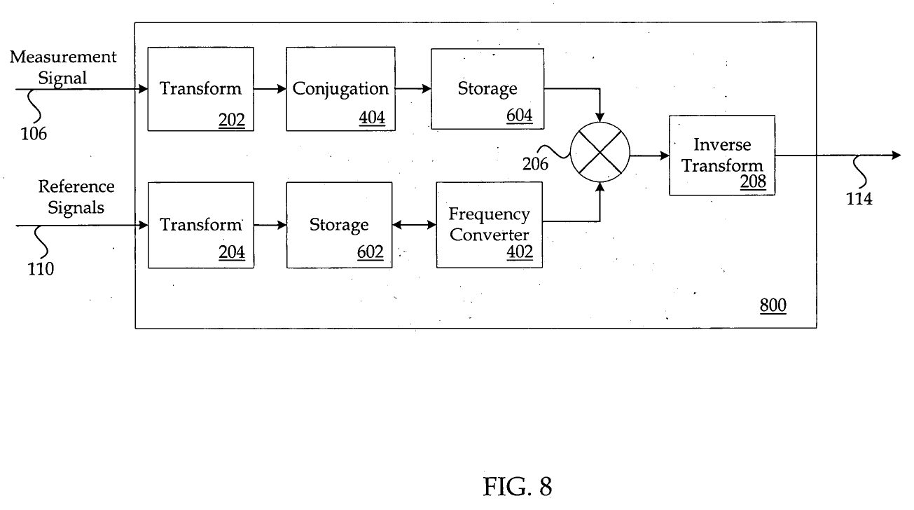

FIG. 8 is a block diagram of a frequency domain time correlation system in accordance with the third embodiment of FIG. 7. Correlation system 800 includes transforms 202, 204, multiplication 206, inverse transform 208, frequency converter 402, conjugation 404, storage 602, and storage 604. Transforms 202, 204, multiplier 206, inverse transform 208, frequency converter 402, conjugation 404, storage 602, and storage 604 function as described in conjunction with FIGS. 4 and 6 in this embodiment in accordance with the invention.

Multiple reference signals are input into transform 204 to convert the time domain data in the signals into frequency domain data. Each reference signal corresponds to a different fractional frequency adjustment, including zero. The transformed reference signals are then stored in storage 602. In this embodiment in accordance with the invention, the fractional amounts represent zero, a ¼, a ½, and a ¾ adjustment to the frequency. Other embodiments in accordance with the invention may utilize different fractional amounts, such as, for example, one-third adjustments or one-eighth adjustments.

A measurement signal is input into transform 202 to convert the time domain data in the signal into frequency domain data. Conjugation 404 receives the frequency domain data in the measurement signal and conjugates the data. The conjugate of the measurement signal is then stored in storage 604. Frequency converter 402 reads the frequency domain data of a reference signal out of storage 602 and varies the frequency of the signal. If the frequency will be adjusted by a fractional amount, the frequency converter 402 selects the reference signal that corresponds to the fractional adjustment. If the frequency is not adjusted by a fractional amount, the zero adjustment reference signal is selected. If the frequency is also adjusted by an integer amount, the frequency converter 402 rotates the frequency domain data values to vary the frequency by the integer amount.

For example, when the adjustment value is 0.5, frequency converter 402 reads the reference signal corresponding to the 0.5 adjustment from storage 602. When the adjustment value is an integer and fractional amount, such as 2.5, frequency converter 402 reads a reference signal that corresponds to the fractional adjustment from storage 602. Frequency converter 402 then varies the 0.5 reference signal by the integer amount 2. In this embodiment in accordance with the invention, frequency converter 402 would vary the 0.5 reference signal by 2 by rotating the data values in the reference signal as described in conjunction with FIG. 4.

Multiplier 206 then multiplies the frequency domain data in the reference signal with the conjugate of the frequency domain data in the measurement signal. The resulting product data are input into inverse transform 208, which converts the data into delay domain data. A strong correlation occurs in the inverse transform output data in the FIG. 8 embodiment when the frequency of the reference signal, through frequency variation, matches (or nearly matches) the frequency of the measurement signal.

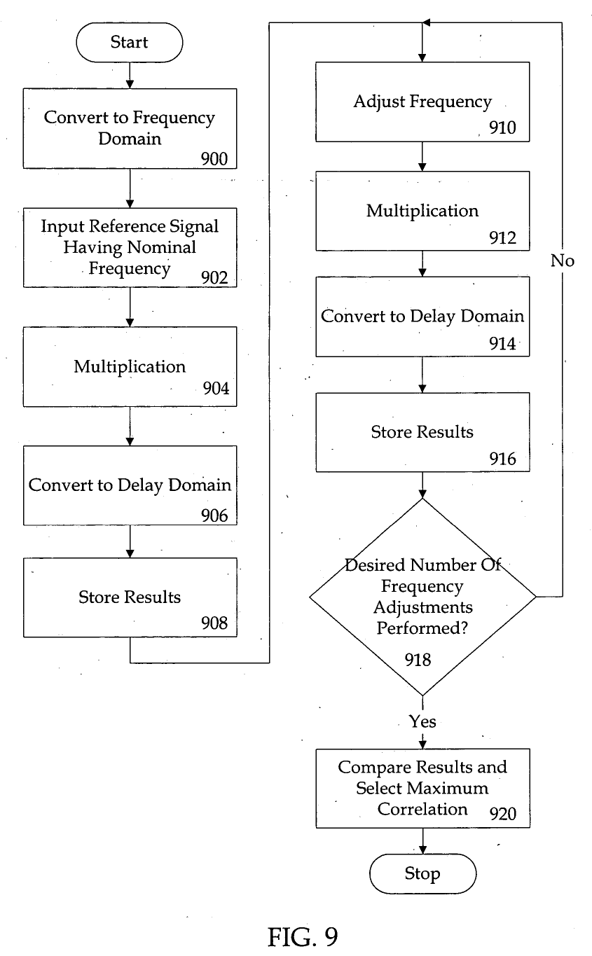

Referring now to FIG. 9, there is shown a flowchart of a method for frequency domain time correlation in a fourth embodiment in accordance with the invention. The process begins at block 900 where time domain data are converted to frequency domain data. The time domain data in the FIG. 9 embodiment includes a measurement signal and a reference signal. A signal having a nominal frequency is used as an initial reference signal, as shown in block 902.

In this embodiment in accordance with the invention, the frequency of the measurement signal typically clusters around a particular nominal frequency, i.e., within a certain tolerance around the nominal frequency. The nominal frequency and the tolerance value are usually specific to an application. The nominal frequency is utilized in the FIG. 9 embodiment to provide a preference as to where the search for a frequency match begins.

The frequency domain data in the measurement signal and the frequency domain data in the nominal frequency signal are then multiplied (block 904). Next, the resulting product data are converted to delay domain data and stored in a memory, as shown in blocks 906 and 908. The nominal frequency is then adjusted at block 910. In this embodiment in accordance with the invention, the nominal frequency is adjusted by a tolerance value. The value of the tolerance value is dependent on the application being measured.

Next, the adjusted nominal frequency signal and the measurement signal are multiplied and the resulting product data converted to delay domain data (blocks 912 and 914). The delay domain data is stored in memory, as shown in block 916. A determination is then made at block 918 as to whether the desired number of frequency adjustments has been performed. If not, the process returns to block 910 and repeats until the desired number of frequency adjustments has occurred.

When all of the frequency adjustments have occurred, the results are compared and the frequency and delay that produce the strongest or maximum correlation are selected (block 920). A strong correlation occurs in the inverse transform output data in this embodiment in accordance with the invention when the frequency of the reference signal, through frequency variation, matches (or nearly matches) the frequency of the measurement signal.

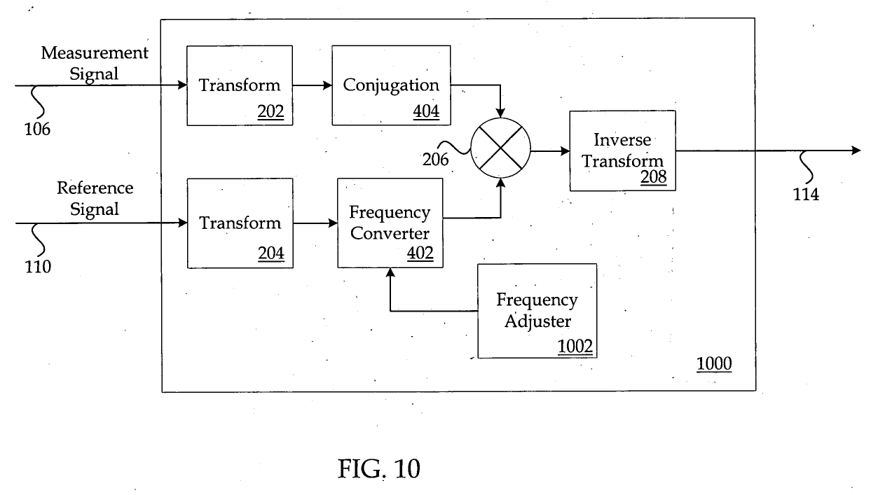

FIG. 10 is a block diagram of a frequency domain time correlation system in accordance with the fourth embodiment of FIG. 9. Correlation system 1000 includes transforms 202, 204, multiplier 206, inverse transform 208, frequency converter 402, conjugation 404, and a frequency adjuster 602. Transforms 202, 204, multiplier 206, inverse transform 208, frequency converter 402, and conjugation 404, function as described in conjunction with FIG. 4 in this embodiment in accordance with the invention.

A signal having a nominal frequency is used as an initial reference signal and is input into transform 204. The nominal frequency signal is based on the application, and provides a preference as to where the search for a frequency match begins. Transform 204 converts the time domain data in the nominal frequency signal to frequency domain data. The frequency domain data in the nominal frequency signal are then input into frequency converter 402. Frequency converter 402 does not vary the nominal frequency initially in this embodiment in accordance with the invention, so the nominal frequency signal is input into multiplier 206.

A measurement signal is input into transform 202 and conjugation 404. Multiplier 206 then multiplies the frequency domain data in the nominal frequency signal with the conjugate of the frequency domain data in the measurement signal. The resulting product data are input into inverse transform 208, which converts the data into delay domain data.

After the data in the nominal frequency signal and the measurement signal are correlated, the frequency adjuster 1002 adjusts the nominal frequency pursuant to a search algorithm in this embodiment in accordance with the invention. The frequency adjuster 1002 inputs the adjustment value or amount into frequency converter 402. Frequency converter 402 then varies the nominal frequency according to the adjustment value. The adjustment value includes integer adjustments in the FIG. 10 embodiment. Fractional adjustments may be implemented in other embodiments in accordance with the invention by utilizing multiple reference signals corresponding to different fractional adjustments, as discussed in conjunction with FIG. 8.

In the FIG. 10 embodiment, the search algorithm adjusts the frequency of the nominal frequency signal by applying a tolerance value to the signal in an alternating lower and higher pattern relative to the nominal frequency. In this embodiment in accordance with the invention, the measurement signal frequency error clusters around the nominal measurement signal frequency. For example, with a nominal frequency offset of zero, the frequency adjuster 1002 adjusts the frequency by −1, +1, −2, +2, . . . −n, +n, where (2n+1) represents the desired number of frequency adjustments. In other embodiments in accordance with the invention, however, the frequency adjuster 1002 can adjust the frequency pursuant to other search algorithms that utilize different tolerance and increment values. The search algorithm is determined by the distribution of the frequency errors in the measurement signal. For example, the distribution may be a nearly linear distribution in another embodiment in accordance with the invention. In this embodiment, the search algorithm may start at one end of the frequency range and step linearly toward the other end of the frequency range.

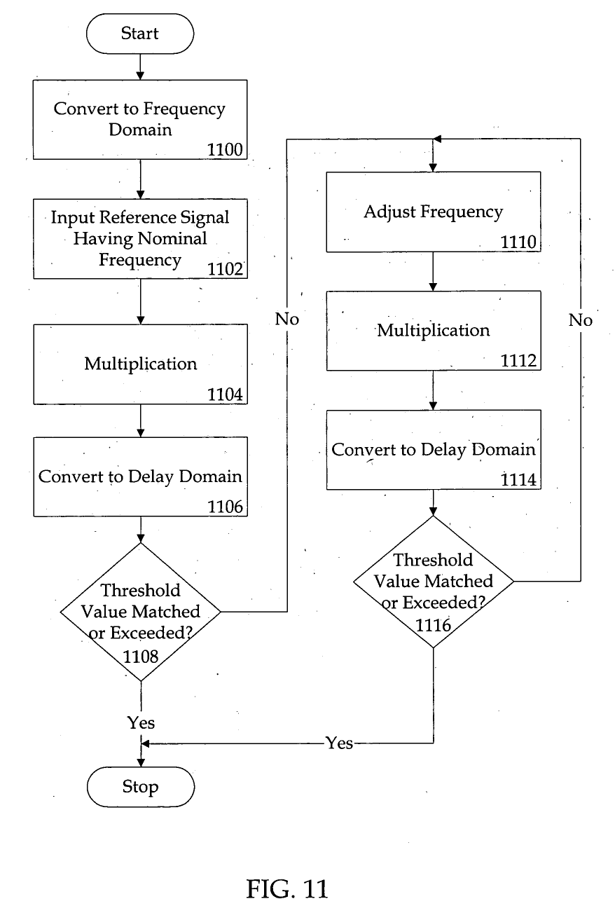

Referring now to FIG. 11, there is shown a flowchart of a method for frequency domain time correlation in a fifth embodiment in accordance with the invention. The process begins at block 1100 where time domain data are converted to frequency domain data. The time domain data in the FIG. 11 embodiment includes a measurement signal and a reference signal.

A signal having a nominal frequency is used as an initial reference signal, as shown in block 1102. Next, the frequency domain data in the measurement signal and the frequency domain data in the nominal frequency signal are multiplied, as shown in block 1104. The resulting product data are then converted to delay domain data (block 1106).

A determination is then made at block 1108 as to whether a correlation value for the correlated data matches or exceeds a correlation threshold value. A correlation threshold value allows the correlation system to detect correlation with an acceptable, but less than perfect, match between the frequency of the measurement signal and the frequency of the reference signal. When a correlation threshold value is set to zero, the correlation search will stop after the nominal frequency correlation. When the correlation threshold value is set to a value approaching one, the correlation search will stop when the frequency of the reference signal matches the frequency of the measurement signal. When the correlation threshold value is set to an appropriate value between zero and one, the correlation search will stop when the frequency of the reference signal reaches an acceptable, but not perfect, equivalence or closeness to the frequency of the measurement signal, which results in a useable correlation. The value of a correlation threshold value depends on the specific parameters in each application.

Returning to block 1108, if the correlation threshold value is matched or exceeded, the process ends. Otherwise the process passes to block 1110, where the nominal frequency is adjusted. The adjustment amount includes integer adjustments in the FIG. 11 embodiment. Fractional adjustments may be implemented in other embodiments in accordance with the invention by utilizing multiple reference signals corresponding to different fractional adjustments, as discussed in conjunction with FIG. 7.

Next, the frequency domain data in the adjusted signal and the frequency domain data in the measurement signal are multiplied and the resulting product data converted to delay domain data (blocks 1112 and 1114). A determination is then made at block 1116 as to whether a correlation value for the correlated data matches or exceeds a correlation threshold value. If the correlation threshold value is matched or exceeded, the process ends. If, not, the process returns to block 1110, where the frequency is adjusted again. The process continues through blocks 1110 to 1116 until the correlation threshold value is matched or exceeded.

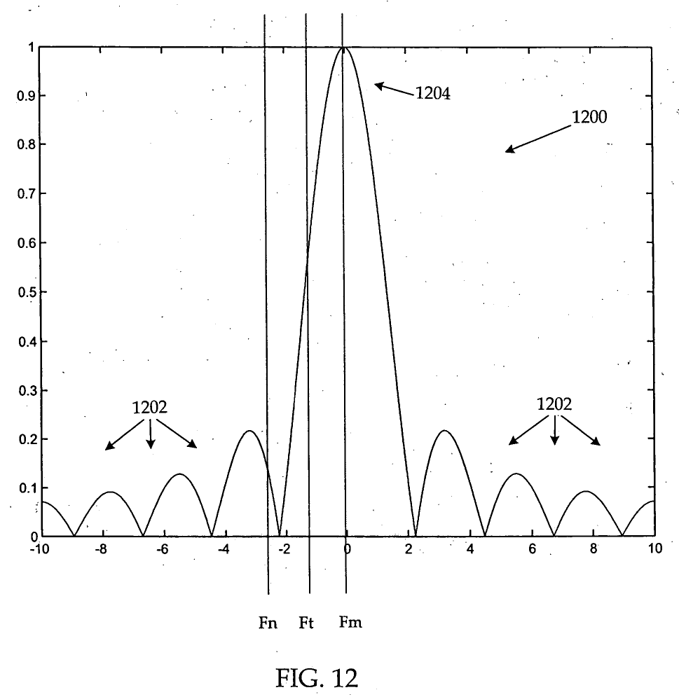

FIG. 12 is a waveform diagram of a correlated signal in accordance with the fourth embodiment of FIG. 11. A correlated signal waveform 1200 typically includes side-lobe responses 1202. The magnitude of the correlated signal is greatest (point 1204) when the frequency of the reference signal matches the frequency of the measurement signal, as indicated by Fₘ in FIG. 12.

In this embodiment in accordance with the invention, the side lobe responses 1202 in the correlated signal increase in magnitude when the frequency of the reference signal approaches Fₘ. And as the frequency of the reference signal moves away from Fₘ, the side lobe responses 1202 in the correlated signal decrease in magnitude. The side lobe responses 1202, and possibly the peak response 1204, are compared with a correlation threshold value in this embodiment in accordance with the invention.

As discussed in conjunction with FIG. 11, a signal having a nominal frequency is used as an initial reference signal. In FIG. 12, Fₙ represents a nominal frequency, and Fₜ represents a threshold frequency corresponding to a correlation threshold value. As shown in FIG. 12, the correlation value at Fₙ is approximately 0.15, and the correlation value at Fₜ is approximately 0.55. Thus, the correlation value (0.15) at the nominal frequency does not match or exceed the correlation value (0.55) at the threshold frequency. Using the technique discussed in conjunction with FIG. 11, the frequency is adjusted until the correlation value for the correlated data matches or exceeds the correlation threshold value.

When the correlation threshold value is set properly, an acceptable correlation may often be found at an offset nearer the nominal frequency than the actual frequency of the measurement signal, allowing the frequency search to terminate before the frequency of the measurement signal is matched by the search. Thus, the use of a correlation threshold value can result in a faster correlation process in those applications where a match is not required. In certain situations, however, the side lobe responses 1202 may generate false detections. Those skilled in the art will recognize that to avoid false detections, further analysis with known techniques may be required to confirm the main lobe has been located. Furthermore, the side lobe responses 1202 may be mitigated through the use of window functions applied to the reference signal.

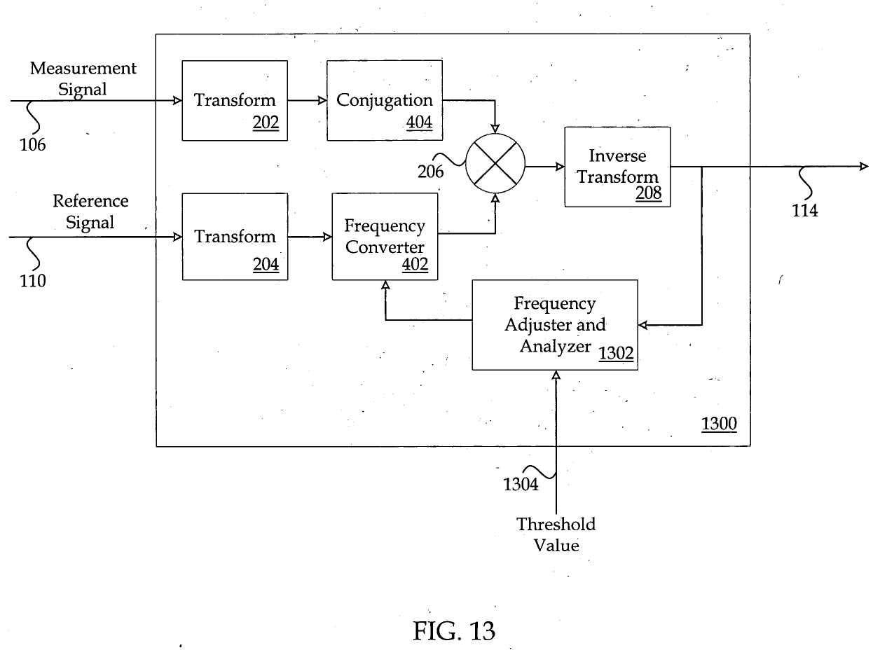

Referring now to FIG. 13, there is shown a block diagram of a frequency domain time correlation system in accordance with the fifth embodiment of FIG. 11. Correlation system 1300 includes transforms 202, 204, multiplier 206, inverse transform 208, frequency converter 402, conjugation 404, and a frequency adjuster and analyzer 1302. Transforms 202, 204, multiplier 206, inverse transform 208, frequency converter 402, and conjugation 404, function as described in conjunction with FIG. 4 in this embodiment in accordance with the invention.

A signal having a nominal frequency is used as an initial reference signal and is input into transform 204. The nominal frequency is based on the application, and provides a preference as to where the search for a frequency match begins. Transform 204 converts the time domain data in the nominal frequency signal to frequency domain data. The frequency domain data in the nominal frequency signal are then input into frequency converter 402. In this embodiment in accordance with the invention, frequency converter 402 does not vary the nominal frequency initially, so the nominal frequency signal is input into multiplier 206.

A measurement signal is input into transform 202 and conjugation 404. Multiplier 206 then multiplies the frequency domain data in the nominal frequency signal with the conjugate of the frequency domain data in the measurement signal. The resulting product data are input into inverse transform 208, which converts the data into delay domain data.

Frequency adjuster and analyzer 1302 analyzes the correlated data output from inverse transform 208 to determine whether a correlation value for the correlated data matches or exceeds a correlation threshold value. The correlation threshold value is input into frequency adjuster and analyzer 1302 via signal line 1304. If the correlation value for the correlated data does not match or exceed the correlation threshold value, the frequency adjuster and analyzer 1302 transmits the adjustment value or amount to frequency converter 402, which in turn varies the frequency according to the adjustment value. In this embodiment in accordance with the invention, frequency adjuster and analyzer 1302 adjusts the frequency pursuant to a search algorithm. As discussed in conjunction with FIG. 10, the search algorithm adjusts the frequency by adding or subtracting a tolerance value to the nominal frequency.

The process of adjusting the frequency of the nominal frequency signal continues until the correlation value of the correlated data output from inverse transform 208 matches or exceeds the correlation threshold value. In the FIG. 13 embodiment, the adjustment value includes integer adjustments. Fractional adjustments may be implemented in other embodiments in accordance with the invention by utilizing multiple reference signals corresponding to different fractional adjustments, as discussed in conjunction with FIG. 8.

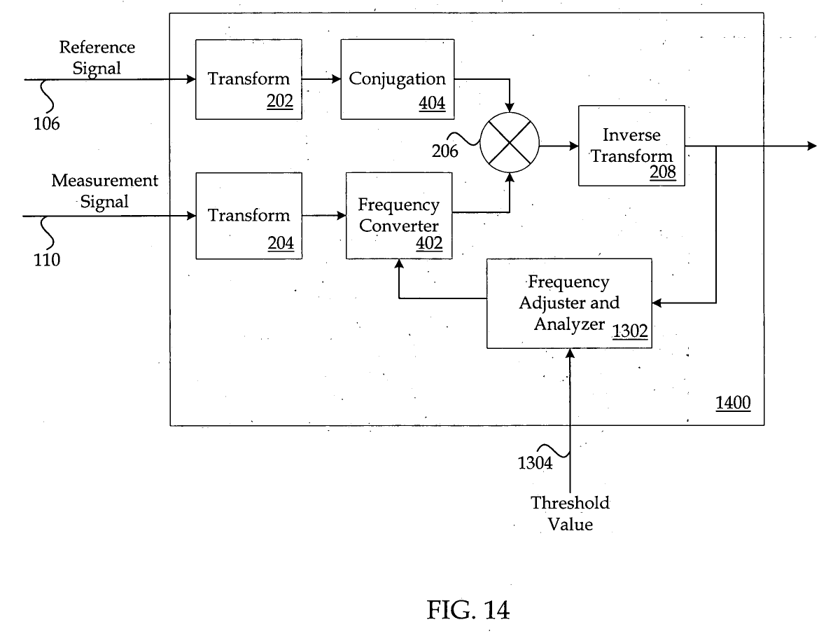

Embodiments in accordance with the invention, however, are not limited to adjusting the frequency of the reference signal. Other embodiments in accordance with the invention can adjust the frequency of the measurement signal. FIG. 14 is a block diagram of a frequency domain time correlation system in a sixth embodiment in accordance with the invention. Correlation system 1400 is similar to correlation system 1300 in FIG. 11, except that the frequency of the measurement signal is adjusted until the correlation value of the correlated data matches or exceeds the correlation threshold value. The frequency of the measurement signal may also be varied instead of the frequency of the reference signal in the embodiments illustrated in FIGS. 4, 6, and 10.

As with the FIG. 4 embodiment, conjugation 404 is not necessary in this embodiment when time reversal of the reference signal is utilized. The transform of the time-reversed reference signal is input directly into multiplier 206, where the measurement signal is multiplied element-by-element with the time-reversed reference signal. The correlated signal is then input into inverse transform 208.

1. A system for frequency domain time correlation, comprising:
a frequency adjuster receiving a first signal comprised of frequency domain data and varying the frequency of the first signal; and
a correlator receiving the varied first signal and a second signal comprised of frequency domain data and correlating the first and second signals to produce a correlated signal.

2. The system of claim 1, further comprising:
a first converter converting time domain data in the first signal into frequency domain data;
a second converter converting time domain data in the second signal into frequency domain data.

3. The system of claim 1, wherein the correlator comprises:
a multiplier receiving the varied first signal and the second signal and multiplying the varied first signal with the second signal to product a product signal; and
a third converter receiving the frequency domain data in the product signal and converting the frequency domain data to delay domain data producing a correlated signal.

4. The system of claim 1, further comprising a storage storing one or more first signals, wherein each first signal represents a fractional frequency adjustment.

5. The system of claim 1, wherein the frequency adjuster varies the frequency of the first signal by rotating data values in the first signal.

6. The system of claim 1, wherein the frequency adjuster varies the frequency of the first signal a predetermined number of times.

7. The system of claim 1, wherein the frequency adjuster adjusts the frequency of the first signal pursuant to a search algorithm.

8. The system of claim 1, further comprising an analyzer receiving the correlated signal and determining whether a correlation value for the correlated signal exceeds a threshold value.

9. A system for frequency domain time correlation, comprising:
a frequency adjuster generating an adjustment value and varying the frequency of a first signal according to the adjustment value, wherein the first signal is comprised of frequency domain data;
a correlator receiving the varied first signal and a second signal comprised of frequency domain data and correlating the first and second signals to produce a correlated signal; and
an analyzer receiving the correlated signal and determining whether a correlation value for the correlated signal at least matches a threshold value.

10. The system of claim 9, further comprising:
a first converter converting time domain data in the first signal into frequency domain data; and
a second converter converting time domain data in the second signal into frequency domain data.

11. The system of claim 9, wherein the correlator comprises:
a multiplier receiving the varied first signal and the second signal and multiplying the varied first signal with the second signal to product a product signal; and
a third converter receiving the frequency domain data in the product signal and converting the frequency domain data to delay domain data producing a correlated signal.

12. The system of claim 9, further comprising a storage storing one or more first signals, wherein each first signal represents a different fractional adjustment value to the frequency of the first signal.

13. The system of claim 9, wherein the frequency adjuster generates the adjustment according to a search algorithm.

14. A method for frequency domain time correlation, comprising:
converting time domain data in a first signal into frequency domain data;
adjusting the frequency of a second signal, wherein the second signal is comprised of frequency domain data; and
correlating the frequency domain data in the first signal with the frequency domain data in the second signal to produce a correlated signal.

15. The method of claim 14, further comprising:
converting the frequency domain data in the correlated signal into time domain data.

16. The method of claim 14, wherein the adjusting of the frequency of the first signal comprises adjusting the frequency of the first signal a predetermined number of times.

17. The method of claim 14, wherein the adjusting of the frequency of the first signal comprises adjusting the frequency of the first signal pursuant to a search algorithm.

18. The method of claim 17, wherein the search algorithm applies a tolerance value to the frequency of the first signal.

19. The method of claim 14, further comprising:
determining whether a correlation value for the correlated signal at least matches a correlation threshold value.

20. The method of claim 14, further comprising:
converting time domain data in the second signal into frequency domain data;
converting time domain data in a third signal into frequency domain data, wherein the third signal represents a fractional adjustment to a frequency of the second signal;
storing the frequency domain data in the second signal and in the third signal in a storage; and
reading the frequency domain data for the third signal out of the storage when the frequency of the second signal is adjusted by the fractional adjustment represented by the third signal.
